(19) United States
(12) Patent Application Publication
(10) Pub. No.: US 2007/0214785 A1
(43) Pub. Date: Sep. 20, 2007

(54) Turbo Charger Unit With Bearings For A Rotor Shaft

(75) Inventors: Kent Giselmo, Vellinge (SE); Jonas Augustinson, Vellinge (SE)

Correspondence Address: WRB-IP LLP, 1217 KING STREET, ALEXANDRIA, VA, 22314, US

(73) Assignee: Volvo Lastvagnar AB, Goteborg (SE)

(21) Appl. No.: 11/576,953

(22) PCT Filed: Oct. 28, 2004
(86) PCT No.: PCT/SE04/01572

§ 371 Date: Apr. 10, 2007

(51) Int. Cl. F02D 23/00

(52) U.S. Cl. 60/598

(57) ABSTRACT

A turbocharger unit has a shaft mounting for a rotor shaft. The shaft supports at one end a turbine wheel and at its other end a compressor wheel. The shaft is supported in a bearing housing by two axially spaced bearing elements, one of which forms an axial support via a shoulder on the shaft. A desired exact bearing pre-load is attainable if a discharger ring is mounted on the shaft by a threaded joint in such a way that the ring forms an axial support acting in the opposite axial direction against the other bearing element.

### BACKGROUND AND SUMMARY

The present invention relates to a shaft mounting for a rotor shaft belonging to a turbocharger unit, which rotor shaft at its one end supports a turbine wheel and at its other end supports a compressor wheel and is supported in a bearing housing by means of two axially spaced bearing elements, one of which forms an axial support via a shoulder on the shaft.

A turbocharger unit can operate at rotation speeds up to around 200,000 r.p.m. The mounting of the rotor of a turbo unit consists either of slide bearings, ball bearings or a combination of the two. Ball bearings produce the lowest power loss. The ball bearing application generally consists of two angular contact bearings, facing each other in a so-called O-arrangement (back-to-back arrangement). The two bearings can have a common outer ring with two elongated, separate inner rings, but can also consist of two normal angular contact bearings fitted in an outer sleeve and with a spacer sleeve between the two inner rings.

The rotation speed of the rotor varies especially under transient conditions, which means that axial forces are generated on the rotor shaft since the load direction is dependent on an increase or decrease in the rotation speed. If axial play is present in the mounting of the rotor shaft, the bearing life is adversely affected and there is also a risk of damage to the bearings.

The inner rings of the ball bearings therefore need a certain external force to ensure that the desired inner pre-load of the bearings is attained. This force must not be too large, however, since there is risk of deformation of the inner rings. This force is usually obtained from the nut of the compressor, The axial force must be sufficient to ensure that the compressor does not slip toward the shaft, since the drive torque of the compressor is transferred by friction between the axial surfaces of the compressor and surrounding parts. This high axial force can be unsuitably high, however, for the bearing inner rings.

It is desirable to produce a shaft mounting for a turbocharger unit, which allows simple adjustment of a desired bearing pre-load without risk of deformation of bearing elements.

A shaft mounting, which according to the invention is configured for this purpose, for a rotation shaft belonging to a turbocharger unit, which rotation shaft at its one end supports a turbine wheel and at its other end supports a compressor wheel and is supported in a bearing housing by means of two axially spaced bearing elements, one of which forms an axial support via a shoulder on the shaft, and is characterized according to the invention in that a discharger ring is mounted on the shaft by means of a threaded joint in such a way that the ring forms an axial support acting in the opposite axial direction against the other bearing element.

### BRIEF DESCRIPTION OF THE FIGURES

The invention will be described in greater detail below with reference to illustrative embodiments shown in the appended drawings, in which:

FIG. 1 shows in diagrammatic representation a longitudinal section thorough a two-stage turbocharger unit,

FIG. 2 shows on a larger scale a shaft mounting used in the turbocharger unit in FIG. 1, and

FIG. 3 shows a section through a discharger ring used in the shaft mounting according to FIG. 2.

### DETAILED DESCRIPTION

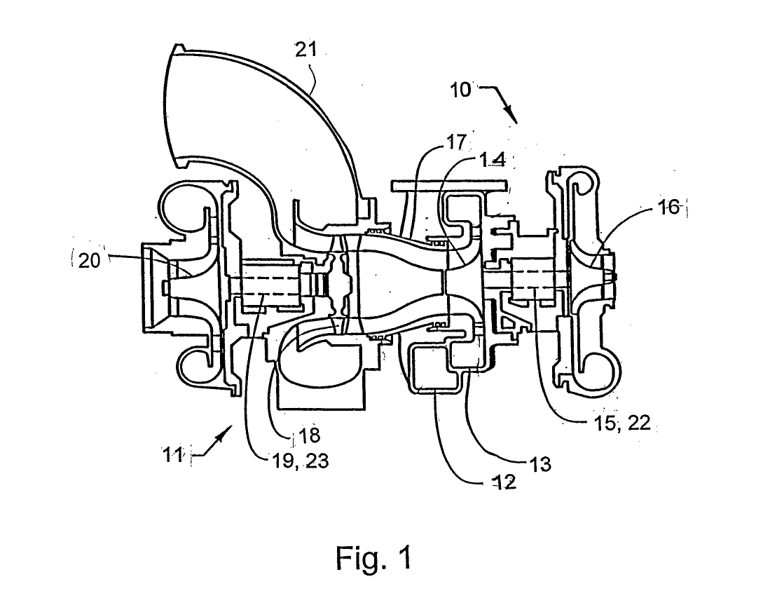

The shaft mounting according to the invention is shown in FIG. 1 applied to a two-stage turbocharger unit, but can also be used on a conventional single-stage turbo unit.

The first stage of the turbocharger unit is constituted by a high-pressure turbo unit 10, which cooperates with a series-connected low-pressure turbo unit 11. Exhaust gases are conducted from an internal combustion engine (not shown), for example a diesel engine, via separate pipe lines and worm-shaped turbine inlets 12, 13, into the turbine wheel 14 of the high-pressure turbo unit, which turbine wheel is mounted on a common shaft 15 with a compressor wheel 16. The exhaust gases are conducted onward via a pipe line 17 to the turbine wheel 18 of the low-pressure turbo unit 11, which mounted on a common shaft 19 with a compressor wheel 20. The exhaust gases are then conducted onward via a pipe line 21 to the exhaust system of the engine.

Filtered inlet air to the engine is conducted to the compressor wheel 20 of the low-pressure turbo unit 11. A pipe line (not shown) conducts the inlet air onward to the compressor wheel 16 of the high-pressure turbo unit 10, from which compressor wheel the pressurized inlet air is conducted to the inlet side of the engine.

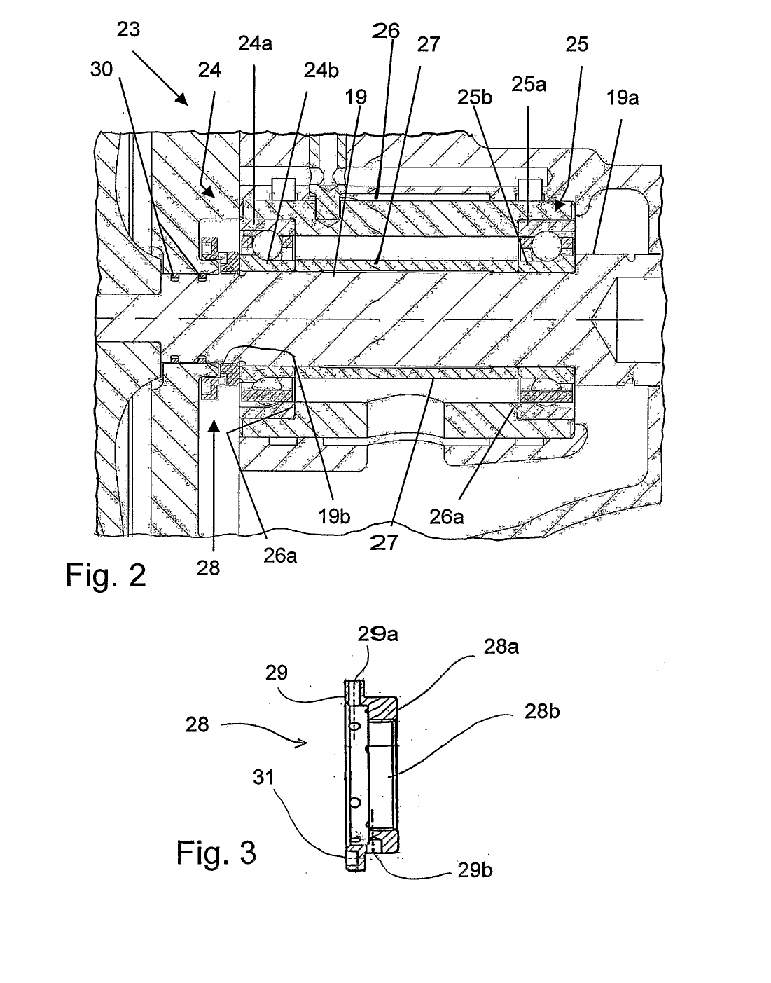

The shaft 15 of the high-pressure turbine is supported by means of a shaft mounting 22 and the shaft 19 of the low-pressure compressor is supported by means of a shaft mounting 23, shown in greater detail in FIG. 2. The shaft mounting 23 consists of two angular contact bearings 24, 25, which are mounted with their outer rings 24a, 25a inside a cylindrical sleeve 26 which is mounted with a certain play in the turbine housing. Radially inwardly directed flanges 26a on the inner side of the sleeve 26 form axial lateral supports for the outer rings. The shaft 19 is inserted through the inner rings 24b, 25b of the bearings 24, 25 from the right in FIG. 2, in such a way that it rests with a radially projecting shoulder portion 19a against the inner ring 25b. On the opposite side of the inner ring 25b rests a spacer sleeve 27, which also bears against the other inner ring 25a. The turbine shaft 19 is provided with an externally threaded portion 19b, which cooperates with an internally “threaded discharger ring 28, shown in section in FIG. 3.

The discharger ring 28 comprises an inner ring portion 28a, with internal thread 28b, and an L-shaped, radially directed flange portion 29. The latter is provided with radially directed ducts 29a and 29b, which are intended to drain away oil from shaft seals 30. Two axial bores 31 in the flange portion 29 allow the bearing inner rings 24b, 25b to be pre-loaded by the use of a tightening tool. Expediently, lock fluid is used when mounting the discharger ring on the shaft 19.

The invention should not be deemed to be limited to the illustrative embodiment described above, but rather a number of further variants and modifications are conceivable within the scope of the subsequent patent claims. For example, the shaft mounting according to the invention can also be applied to the high-pressure turbo unit shown in FIG. 1. If the inner rings 24b, 25b of the ball bearings are configured so as to be laterally extended one toward the other, these can rest directly one against the other, in which case the sleeve 26 becomes superfluous.

1. A turbocharger unit comprising:
a shaft mounting for a rotor shaft, the rotor shaft having a first and a second end, the rotor shaft, at its first end, supporting a turbine wheel and, at its second end, supporting a compressor wheel, and
axially spaced bearing elements for supporting the rotor shaft in a bearing housing, a first one of the bearing elements forming an axial support with a shoulder on the shaft, the rotor shaft being provided with an externally threaded portion and a second one of the bearing elements forming another axial support with a discharger ring, the discharger ring being mounted on the shaft by a threaded joint with the externally threaded portion of the rotor shaft, the ring being adapted to oppose axial movement of the second bearing in an opposite axial direction than a direction in which the shoulder opposes axial movement of the first bearing element.

2. The turbocharger unit as claimed in claim 1, wherein the bearing elements bear axially one against the other via an intermediate spacer sleeve.

3. The turbocharger unit as claimed in claim 1, wherein the discharger ring is mounted on the shaft by torque traction to a specific tightening torque.

4. The turbocharger unit as claimed in claim 1, wherein the threaded joint is mounted with lock fluid.

5. The turbocharger unit as claimed in claim 1, wherein the bearing elements comprise ball bearings.

6. The turbocharger unit as claimed in claim 5, wherein inner rings of the ball bearings are laterally extended and rest directly one against the other.

7. The turbocharger unit as claimed in claim 2, wherein the discharger ring is mounted on the shaft by torque traction to a specific tightening torque.

8. The turbocharger unit as claimed in claim 2, wherein the threaded joint is mounted with lock fluid.

9. The turbocharger unit as claimed in claim 2, wherein the bearing elements comprise ball bearings.

10. The turbocharger unit as claimed in claim 9, wherein inner rings of the ball bearings are laterally extended and rest directly one against the other.

11. The turbocharger unit as claimed in claim 3, wherein the threaded joint is mounted with lock fluid.

12. The turbocharger unit as claimed in claim 3, wherein the bearing elements comprise ball bearings.

13. The turbocharger unit as claimed in claim 12, wherein inner rings of the ball bearings are laterally extended and rest directly one against the other.

14. The turbocharger unit as claimed in claim 7, wherein the threaded joint is mounted with lock fluid.

15. The turbocharger unit as claimed in claim 7, wherein the bearing elements comprise ball bearings.

16. The turbocharger unit as claimed in claim 15, wherein inner rings of the ball bearings are laterally extended and rest directly one against the other.

17. The turbocharger unit as claimed in claim 5, wherein the bearing elements comprise ball bearings.

18. The turbocharger unit as claimed in claim 17, wherein inner rings of the ball bearings are laterally extended and rest directly one against the other.

19. The turbocharger unit as claimed in claim 14, wherein the bearing elements comprise ball bearings.

20. The turbocharger unit as claimed in claim 19, wherein inner rings of the ball bearings are laterally extended and rest directly one against the other.
